(19) United States
(12) Patent Application Publication
(10) Pub. No.: US 2007/0284431 A1
(43) Pub. Date: Dec. 13, 2007

(54) Power Supply Unit with Smart Control on Cooling Device

(75) Inventor: Chun-Wei Pan, Lujhu Township (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: CHANNEL WELL TECHNOLOGY CO., LTD., Lujhu Township (TW)

(21) Appl. No.: 11/760,327

(22) Filed: Jun. 8, 2007

(30) Foreign Application Priority Data
Jun. 9, 2006 (TW) 95120644

(51) Int. Cl. G06F 17/00

(52) U.S. Cl. 235/375

(57) ABSTRACT

A power supplying unit with a smart control on a cooling device is described. The smart power supplying unit is used in electronic devices with a cooling device to actively control the system temperature of the electronic devices to prevent the system temperature from being too high, and to maintain the normal operation of the electronic device. The smart power supplying unit includes a power supply unit, one or several parameter measuring devices, and a smart controller. The parameter measuring devices are preferably placed in the power supply unit to measure parameters, such as total or individual output power or the temperature at a preset position in the power supply unit. The smart controller adjusts the output cooling power of the cooling device according to the measured parameters.

### RELATED APPLICATIONS

This application claims priority to Taiwan Application Serial Number 95120644, filed Jun. 9, 2006, which is herein incorporated by reference.

### FIELD OF THE INVENTION

The present invention generally relates to a power supply unit. More particularly, this invention relates to a power supply unit with smart control on the cooling device (hereinafter referred to as the smart power supplying unit).

### BACKGROUND OF THE INVENTION

Since the science and technology are highly developed, electronic devices, such as home appliance products and computer products, are gradually entering into people's life. Most electronic devices use direct current (DC) to drive the internal electronic elements therein but city power companies provide the alternating current (AC) to houses through the power grid. Therefore, some electronic devices are driven by batteries and others, most of them, first convert the AC power into a desired DC power voltage with a power supply unit to drive the electronic devices.

Meanwhile the functionalities of the electronic devices are becoming powerful. The microprocessor or the processing unit of the electronic device is very advanced. Therefore, the semiconductor manufacturing processes have very precise requirements, and the electric circuit layouts of semiconductors have become more complicated and more sophisticated. Complicated and sophisticated semiconductors have higher power consumption, which results in, for example, an increase in the operating temperature thereof.

The high operating temperature in the electronic device can cause instabilities in an operating system. Furthermore, if the operating temperature is too high, the performance and stability decreases and the operating system may even crash, in extreme situations. To effectively prevent high operating temperatures in the electronic device, especially computer equipment, some of electronic devices are equipped with temperature sensors on the motherboard thereof or directly measure the operating temperature of the central processing unit (CPU). When the operating temperature is too high, the electronic device turns on or enhances a cooling power thereof. However, this kind of passive cooling system is not sufficient for advanced computer equipment. In addition, the conventional cooling system has to rely on the temperature sensor on the motherboard or in the CPU and the control program is preset making it difficult to upgrade the electronic device and the cooling system battles to adapt to the environmental change. Therefore, there is a need to promptly actively regulate the operating temperature for the electronic device, especially the computer, to run the electronic device smoothly.

### SUMMARY OF THE INVENTION

One object of the present invention is to provide a smart power supplying unit to control the cooling power of a cooling device according to the total or individual power output of the power supply unit to effectively and actively prevent from a temperature increase in the electronic device.

Another object of the present invention is to provide a smart power supplying unit to control the cooling power of a cooling device according to the operating temperature of the smart power supplying unit to effectively and actively prevent the temperature increasing in the electronic device.

Another object of the present invention is to provide a smart power supplying unit to control the cooling power of a cooling device according to the total or individual power output and the operating temperature of the smart power supplying unit to effectively and actively prevent the temperature increasing in the electronic device.

Yet another object of the present invention is to provide a smart power supplying unit that measures the total or individual power output and/or the operating temperature of the smart power supplying unit after the electronic device is turned on for about a predetermined time. According to the measured data, a controller of the smart power supplying unit can reason out a type of the electronic device, a typical heat quantity generated by the electronic device, heat dissipation power of the electronic device and the environmental temperature so as to adjust the control parameters and programs thereof to achieve an adaptive parameter adjustment (APA) function for the smart power supply and the electronic device. Therefore, although the components of the electronic device is changed and/or the operating environment is different, the APA controller can automatically adapt to a new operating mode and choice preferred control parameters and programs to control the cooling device so that the smart power supplying unit with the APA function can be utilized on various electronic devices.

Still another object of the present invention is to provide a smart power supplying unit with a real-time adaptive parameter adjustment (RAPA) function. The smart power supply can measure the total or individual power output and/or the operating temperature of the smart power supplying unit after the electronic device is turned on for about a predetermined time to set preferred control parameters and programs for the cooling device. The RAPA smart power supplying unit can prompt adjust control parameters and programs to achieve a preferred cooling effect according to total or individual power output and/or a operating temperature of the smart power supplying unit when the electronic device is running. The RAPA smart power supplying unit rectifies the initial control parameters and programs determined when the electronic device is turned on so as to effectively prevent from running undesired control parameters and programs caused by abnormally turning off and turning on the electronic device.

To achieve these and other advantages and in accordance with the purpose of the present invention, as embodiment and broadly described herein, the present invention provides a smart power supplying unit for an electronic device with a cooling device to actively control the system temperature of the electronic device and prevent system instabilities caused by a high operating temperature. The smart power supplying unit includes a power supply unit, one or more than one parameter measuring devices and a smart controller.

The parameter measuring device is disposed inside the smart power supplying unit to measure one or more than one parameter of the smart power supplying unit. The smart controller is electrically connecting to the parameter measuring device to receive the measured data therefrom to determine the cooling power of the cooling device, such as the cooling device of the electronic device, a central processing unit or a graphic card.

The parameter measuring device is preferably an electrical power detector to measure total output power of the power supply unit or individual output power of single power output interface of the power supply unit. Alternatively, the parameter measuring device is a temperature detector disposed at a predetermined position, such as on the heat fins of the power supply unit, in the power supply unit to measure a temperature thereof to determine the cooling power of the cooling device.

The smart power supplying unit further includes a system temperature detector be preferably disposed inside the electronic device and electrically connected to the smart controller. The system temperature detector measures the system temperature of the electronic device and transmits to the smart controller. The smart controller can control the cooling power of the cooling device according to the system temperature, and foregoing total or individual electrical output power and the predetermined position temperature.

The smart power supplying unit can further include an adaptive parameter adjustment (APA) function to adjust the control parameters and programs thereof according to measured data of the total power output, individual power output, the operating temperature thereof and/or the operating temperature of the system at a predetermined time after the electronic device is turned on. The smart controller can use the foregoing measured data to estimate the type of electronic device, a typical amount of heat generated by the electronic device, heat dissipation capacity and environmental temperature to adjust the control parameters for the cooling device. In one embodiment, the electronic device is a computer and the predetermined time is preferably about 2-3 minutes for the smart controller to estimate the system specification of the computer, for example, a Pentium IV CPU, Pentium III CPU and so on.

The smart power supply can further achieve the real-time adaptive parameter adjustment (RAPA) function to real-time set preferred control parameters and programs for the cooling device according to the total or individual power output and/or a operating temperature of the smart power supplying unit when the electronic device is running. The RAPA smart power supplying unit can effectively rectify the current control parameters and programs determined when the electronic device is turned on so as to prevent running undesired control parameters and programs caused while abnormally turning off and immediately turning on the electronic device.

Another preferred embodiment of the present invention is to provide a smart control module including a smart controller and a parameter measuring device. The smart control module can control a cooling device of an electronic device to maintain a system temperature of the electronic device by measuring a parameter of an output interface, electrically connecting to smart controller, of a power supply unit whether the power supply unit is disposed inside or outside of the electronic device.

The parameter measuring device is preferably an electrical power detector to measure the output power of the power supply unit. Alternatively, the parameter measuring device is a temperature detector disposed at a predetermined position, such as heat fins of the power supply unit, in the power supply unit to measure the temperature of the predetermined position. The smart control module preferably includes a system temperature detector to measure the system temperature of the electronic device.

Hence, the smart power supplying unit and the smart control module can actively adjust the system temperature of the electronic device according to total or individual power output of the power supply unit so that the smart power supplying unit can increase the cooling power before the operating temperature of the electronic device is increased. In addition, the smart power supplying unit and the smart control module can further estimate the system temperature of the electronic device according to a predetermined position temperature thereof.

Furthermore, the smart power supplying unit can provide an adaptive parameter adjustment function to automatically adapt to various systems, various electronic devices, and/or various operating environments. The smart power supplying unit can further provide a real-time adaptive parameter adjustment (RAPA) function to adjust the cooling device control parameters and programs in real-time to prevent incorrect parameters and programs caused by long term operation or an abnormal operation on the electronic device.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a block diagram of a preferred embodiment of the smart power supplying unit according to the present invention; and

FIG. 2 illustrates a response diagram of the preferred embodiment of the smart power supplying unit according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

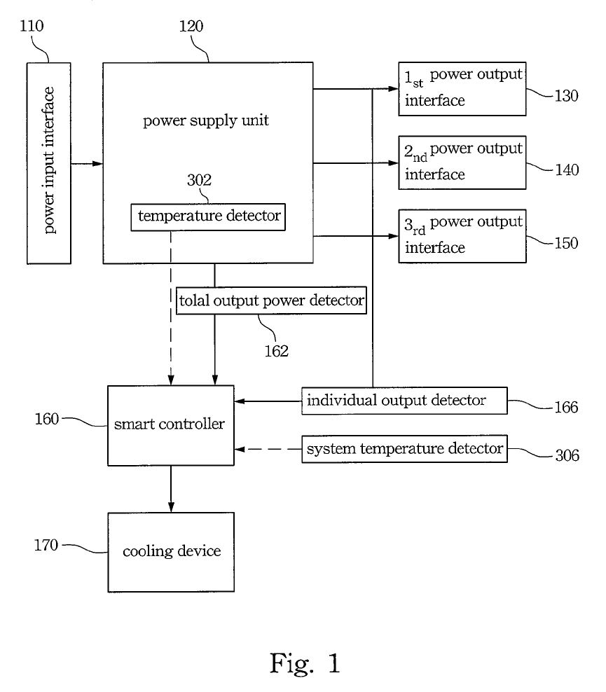

FIG. 1 is a block diagram of the preferred embodiment of the smart power supplying unit according to the present invention. The smart power supplying unit includes a power input interface 110, a power supply unit 120, at least one power output interface, such as a first power output interface 130, a second power output interface 140 and/or a third power output interface 150, and a smart controller 160.

The smart controller 160 uses a parameter measuring device, such as an output power detector 162, to detect the magnitude of the total output power of the power supply unit 120 to forecast the total heat generated by the electronic device and the range of operating temperatures of the electronic device. When the output power is increased, the smart controller 160 can forecast the subsequent operating temperature of the electronic device according to the actual power output of the power supply unit 120 and the relationship between the power output of the power supply unit 120 and the operating temperature of the electronic device. In addition, the smart controller 160 further increases the cooling power of the cooling device 170 to cool down the electronic device before the operating temperature of the electronic device is increased so as to maintain the operating temperature of the electronic device stably. Furthermore, the heat generated by the electronic device can be effectively removed from the electronic device to prevent the heat from being trapped inside the electronic device and damaging the electronic device or wasting energy. The cooling device 170 can be a system cooling device, a CPU cooling device and/or a cooling device of a graphic card.

Hence, the electronic device with the smart power supplying unit can effectively maintain the operating temperature thereof in a stable and smooth condition. The smart power supplying unit can increase the cooling power to reduce the operating temperature of the electronic device before the operating temperature is increased so that the cooling efficiency of the cooling device 170 is increased and the lifespan of the electronic components of the electronic device is also increased.

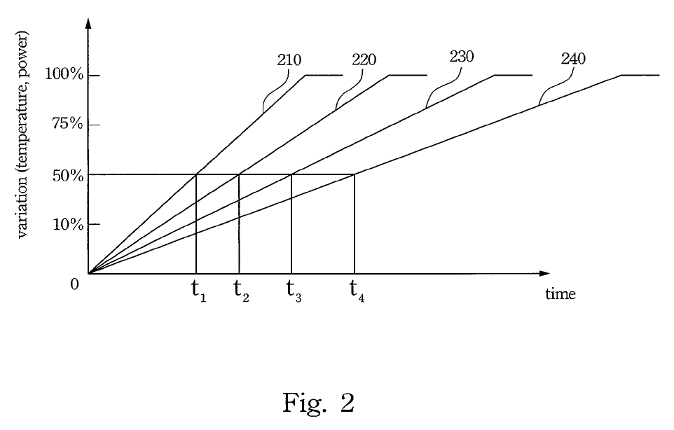

FIG. 2 is a response time diagram of the preferred embodiment of the smart power supplying unit according to the present invention. Compared with the variation rate curves, such as the curves of the temperature and the output power variation, the slope of the power consumption curve 210 of the power supply unit is larger than the slope of the CPU temperature curve 220, the slope of the CPU temperature curve 220 is larger than the slope of the power supply unit temperature curve 230, and the slope of the power supply unit temperature curve 230 is generally larger than the slope of the motherboard temperature curve 240, when the temperature detector of the power supply unit is disposed on a suitable place, for example, on the heat fins of the power supply unit 120.

The power consumption curve 210 of the power supply unit is illustrated the measured data of the electrical power output of the power supply unit 120, the CPU temperature curve 220 is illustrated the CPU temperature variation, the motherboard temperature curve 240 is generally illustrated by a system temperature variation. The power supply unit temperature curve 230 is illustrated by a predetermined position temperature variation in the power supply unit 120, for example, the temperature variation of the heat fins of the power supply unit 120. Conventionally, the cooling device is adjusted the cooling power thereof according to the motherboard temperature curve 240 or the CPU temperature curve 220.

Referring to FIG. 2, when the power consumption curve 210 of the power supply unit arrives at a predetermined value, such as 50%, the response time thereof is about t1. In the same manner, the response time is about t2 for the CPU temperature variation, t3 for the temperature variation of heat fins in the power supply unit 120, and t4 for the temperature variation measured from the conventional mother board.

Accordingly, the response time of the electrical power output variation rate of the power supply unit 120 is faster and more advanced than the other response times of the foregoing variation curves. Therefore, the cooling device 170 has enough time to exhaust the heat inside the electronic device in advance so as to effectively reduce the operating temperature of the electronic device and prevent the system from being damaged or energy for being wasted caused by the trapped heat inside the electronic device.

In addition, the smart power supplying unit can utilize a temperature detector 302 disposed at a predetermined position inside the power supply unit 120. The temperature of the predetermined position, such as the temperature of the heat fins of the power supply unit 120, is proportional to the temperature of the system temperature and able to respond in advance. The smart power supplying unit can also adjust the control program and parameters according to the measured data of the total output power detector 162, the individual output power detector 166, the temperature detector 302 inside the power supply unit, and the system temperature detector 306.

Hence, the smart power supplying unit according to the present invention can quickly adjust the system temperature of the electronic device by measuring the output power and the temperature of the power supply unit.

Furthermore, for different operating environments, the smart power supplying unit can further include an adaptive parameter adjustment (APA) function. The smart power supplying unit can utilize the total output power detector 162 to measure the total power output, the individual output power detector 166 to measure a single channel power output, such as the first power output interface 130, the second power output interface 140 or the third power output interface 150, the temperature detector 302 to measure the temperature of the power supply unit 120 and/or the system temperature detector 306 to measure the system temperature after the electronic device is turned on for about a predetermined time. The smart controller 160 can use the foregoing measured data to estimate the type of the electronic device, the typical amount of heat generated by the electronic device, heat dissipation capacity and the environmental temperature and adjust the control parameters and programs.

In one embodiment, the temperature detector 302 can first measure the temperature T0 in a predetermined position after the electronic device is turned on for about 2-3 minutes and transmit the data T0 to the smart controller 160, and smart controller 160 adjusts the cooling device 170 to a desired operation mode. The temperature of the power supply unit 120 is generally relative to the actual output power and the system temperature. When the smart power supplying unit is used in a low-level CPU, such as the Pentium III CPU, the operating temperature thereof is lower so that the operating temperature of the electronic device is also lower. Therefore, the smart controller 160 can adjust the control parameters to fit this kind of CPU and the cooling curve thereof.

While the computer is running, the temperature detector 302 can further measure the temperature of the predetermined position of the power supply unit 120 and the temperature is recorded as T1 and transmitted to the smart controller 160. When T1 is higher than T0, the previous control parameters and programs can functionally work and does not need to be adjusted. When T1 is lower than T0, the previous control parameters and programs is unsuitable for the electronic device, the smart controller 160 can adjust the control parameters and programs to improve the operation mode of the cooling device and records the value of temperature T1 as the initial temperature T0. The real-time adaptive parameter adjustment is therefore achieved with cycle detecting and adjusting.

When the computer is restarted, or suddenly shut down and restarted again, the temperature T0 may therefore be higher than normal and the smart controller with the adaptive parameter adjustment may therefore set up abnormal control parameters and programs, undesired control parameters and programs, that are unsuitable for the computer and reduces the cooling efficiency of the cooling device. When the temperature is normal again due to a long term in a low load operation or an idle operation, the temperature T1 may be lower than T0. The smart power supplying unit can adjust the control parameters and programs again to fit the actual operating conditions of the computer.

Therefore, the smart power supplying unit can use the smart controller to automatically achieve the adaptive parameter adjustment function so as to suitable to be utilized in various electronic devices and systems, such as desktop computers, notebook computers, server computers, copy machines, projectors, routers, PC Clusters and so on.

Hence, the smart power supplying unit according to the present invention can actively adjust the cooling power of the cooling device in advance according to the measured data of the output power or the temperature thereof. The smart power supplying unit according to the present invention can further achieve the adaptive parameter adjustment function with the smart controller and the temperature detector so as to suitable to be used on various electronic devices.

In addition, some power supply units for the electronic devices are externally connected to the electronic devices so that the smart controller can combine the parameter measuring devices to form a smart control module to electrically connected to the power supply unit and operate the cooling device of the electronic device so as to effectively control the system temperature of the electronic device.

The smart power supplying unit can actively adjust the operating power of a cooling device to prevent the operating temperature in an electronic device from increasing, before the operating temperature is increased, according to the power output of the smart power supplying unit itself and/or a temperature of a predetermined position thereof so as to effectively increase the operating stability of the electronic device. In addition, the smart power supplying unit with an adaptive parameter adjustment function can adjust the control parameters and programs thereof according to measured data of the total power output, individual power output, the operating temperature thereof and/or the operating temperature of the system at a predetermined time after the electronic device is turned on. In addition, the smart power supplying unit can further provide a real-time adaptive parameter adjustment (RAPA) function to real-time adjust the control parameters and programs of the cooling device when the electronic device is running.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A smart power supplying unit for an electronic device with a cooling device to control a system temperature of the electronic device, the smart power supplying unit comprising:
a power supply unit;
a parameter measuring device electrically connected to the power supply unit;
a smart controller electrically connected to the parameter measuring device to receive measured data from the parameter measuring device to determine a cooling power of the cooling device.

2. The smart power supplying unit of claim 1, wherein the parameter measuring device comprises an electrical power detector to measure an output power of the power supply unit.

3. The smart power supplying unit of claim 1, wherein the power supply unit further comprises a plurality of electrical power output interfaces to provide electrical power for the electronic device.

4. The smart power supplying unit of claim 3, wherein the parameter measuring device comprises an electrical power detector to measure the electrical power of one of the electrical power output interfaces.

5. The smart power supplying unit of claim 1, wherein the parameter measuring device comprises a temperature detector disposed at a predetermined position in the power supply unit to measure a temperature of the predetermined position.

6. The smart power supplying unit of claim 5, wherein the temperature detector is disposed on heat fins of the power supply unit.

7. The smart power supplying unit of claim 6, wherein the smart controller adjusts an operation mode of the cooling device according to the temperature of the predetermined position.

8. The smart power supplying unit of claim 7, wherein the temperature detector measures the temperature of the predetermined position after the electronic device is turned on a first predetermined time and transmit the measured temperature to the smart controller.

9. The smart power supplying unit of claim 8, wherein the first predetermined time is about 2-3 minutes.

10. The smart power supplying unit of claim 9, wherein the temperature detector further measures the temperature of the predetermined position after the electronic device is turned on a second predetermined time and transmit the measured temperature to the smart controller to adjust the operation mode of the cooling device.

11. The smart power supplying unit of claim 1, further comprising a system temperature detector electrically connected to the smart controller to measure the system temperature of the electronic device.

12. The smart power supplying unit of claim 11, wherein the smart controller adjusts an operation mode of the cooling device according to the system temperature.

13. The smart power supplying unit of claim 12, wherein the system temperature detector measures the system temperature and transmits to the smart controller after the electronic device is turned on for a first predetermined time.

14. The smart power supplying unit of claim 13, wherein the first predetermined time is about 2-3 minutes.

15. The smart power supplying unit of claim 14, wherein the system temperature detector measures the system temperature and transmits to the smart controller after the electronic device is turned on for a second predetermined time to adjust the operation mode of the cooling device.

16. A smart control module for an electronic device with a power supply unit and a cooling device to control a system temperature of the electronic device, the control module comprising:
a parameter measuring device electrically connected to the power supply unit;
a smart controller electrically connected to the parameter measuring device to receive measured data from the parameter measuring device to determine a cooling power of the cooling device.

17. The smart control module of claim 16, wherein the parameter measuring device comprises an electrical power detector to measure an output power of the power supply unit.

18. The smart control module of claim 16, wherein the parameter measuring device comprises a temperature detector disposed at a predetermined position in the power supply unit to measure a temperature of the predetermined position.

19. The smart control module of claim 18, wherein the temperature detector is disposed on heat fins of the power supply unit.

20. The smart control module of claim 18, wherein the smart controller adjusts an operation mode of the cooling device according to the temperature of the predetermined position.

21. The smart control module of claim 20, wherein the temperature detector measures the temperature of the predetermined position after the electronic device is turned on for a first predetermined time and transmits the measured temperature to the smart controller.

22. The smart control module of claim 21, wherein the first predetermined time is about 2-3 minutes.

23. The smart control module of claim 21, wherein the temperature detector further measures the temperature of the predetermined position after the electronic device is turned on for a second predetermined time and transmits the measured temperature to the smart controller to adjust the operation mode of the cooling device.

24. The smart control module of claim 16, further comprising a system temperature detector electrically connected to the smart controller to measure the system temperature of the electronic device.

25. The smart control module of claim 24, wherein the smart controller adjusts an operation mode of the cooling device according to the system temperature.

26. The smart control module of claim 25, wherein the system temperature detector measures the system temperature and transmits to the smart controller after the electronic device is turned on for a first predetermined time.

27. The smart control module of claim 26, wherein the first predetermined time is about 2-3 minutes.

28. The smart control module of claim 26, wherein the system temperature detector measures the system temperature and transmits to the smart controller after the electronic device is turned on for a second predetermined time to adjust the operation mode of the cooling device.
